(19) United States
(12) Patent Application Publication
(10) Pub. No.: US 2025/0200563 A1
(43) Pub. Date: Jun. 19, 2025

(54) METHOD OF ACQUIRING ELECTRONIC CERTIFICATE AND BILLING SETTING METHOD

(71) Applicant: TOYOTA JIDOSHA KABUSHIKI KAISHA, Toyota-shi (JP)

(72) Inventors: Takahiro MISAWA, Okazaki-shi (JP); Takahiro UEKI, Toyota-shi (JP)

(73) Assignee: TOYOTA JIDOSHA KABUSHIKI KAISHA, Toyota-shi (JP)

(21) Appl. No.: 18/958,097

(22) Filed: Nov. 25, 2024

(30) Foreign Application Priority Data
Dec. 13, 2023 (JP) 2023-210312

(51) Int. Cl. G06Q 20/38; B60L 53/66; G06Q 20/32; H04W 4/44

(52) U.S. Cl. CPC G06Q 20/38215; B60L 53/665; G06Q 20/325; H04W 4/44

(57) ABSTRACT

A first step of determining whether or not an electronic certificate can be acquired by wireless communication using a communication device until a vehicle arrives at a charging station based on a travel route from a current location to a destination and a position of the charging station, and a second step of acquiring the electronic certificate by wireless communication using the communication device before the vehicle arrives at the charging station when it is determined that the electronic certificate can be acquired by wireless communication using the communication device before the vehicle arrives at the charging station.

### CROSS-REFERENCE TO RELATED APPLICATION

This application claims priority to Japanese Patent Application No. 2023-210312 filed on Dec. 13, 2023, incorporated herein by reference in its entirety.

### BACKGROUND

### 1. Technical Field

The present disclosure relates to a method of acquiring an electronic certificate and a billing setting method.

### 2. Description of Related Art

Hitherto, as this type of method of acquiring an electronic certificate, there is proposed a method in which, in a vehicle including a power storage device (rechargeable battery), a storage device capable of storing information, and a communication device (in-vehicle communication device) for wirelessly exchanging information with the outside, an electronic certificate to be used for charging the power storage device with electric power from a charger (charging equipment) installed in a charging station is acquired and stored in the storage device (memory) (see, for example, Japanese Unexamined Patent Application Publication No. 2022-61185 (JP 2022-61185 A)). In this method, the electronic certificate is acquired from an external server via the communication device when a user operates his/her portable terminal device.

### SUMMARY

In the above method of acquiring an electronic certificate, however, the electronic certificate cannot be acquired when the user does not carry the terminal device. In this case, the charger installed in the charging station cannot be used and the power storage device cannot be charged even when the vehicle arrives at the charging station.

A method of acquiring an electronic certificate and a billing setting method according to the present disclosure are mainly intended to charge a power storage device mounted on a vehicle with electric power from a charger installed in a charging station more reliably.

The method of acquiring an electronic certificate and the billing setting method according to the present disclosure adopt the following means in order to achieve the above main object.

A first aspect of the present disclosure relates to a method of acquiring, in a vehicle including a power storage device and a communication device configured to exchange information by at least wireless communication, an electronic certificate to be used for charging the power storage device with electric power from a charger installed in a charging station. The method includes determining whether the electronic certificate is acquirable by the wireless communication using the communication device before the vehicle arrives at the charging station based on a travel route from a current location to a destination and a location of the charging station, and acquiring the electronic certificate by the wireless communication using the communication device before the vehicle arrives at the charging station when a determination is made that the electronic certificate is acquirable by the wireless communication using the communication device before the vehicle arrives at the charging station.

In the method according to the first aspect of the present disclosure, a determination is made as to whether the electronic certificate is acquirable by the wireless communication using the communication device before the vehicle arrives at the charging station based on the travel route from the current location to the destination and the location of the charging station. The electronic certificate is acquired by the wireless communication using the communication device before the vehicle arrives at the charging station when a determination is made that the electronic certificate is acquirable by the wireless communication using the communication device before the vehicle arrives at the charging station. Thus, the electronic certificate can be acquired before the vehicle arrives at the charging station. As a result, the power storage device mounted on the vehicle can be charged more reliably with the electric power from the charger installed in the charging station.

A second aspect of the present disclosure relates to a method of acquiring, in a vehicle including a power storage device, an electronic certificate to be used for charging the power storage device with electric power from a charger installed in a charging station. The method includes acquiring the electronic certificate from the charger after the vehicle arrives at the charging station when the number of previous failures in the acquiring of the electronic certificate from the charger is less than a predetermined number of times.

In the method according to the second aspect of the present disclosure, the electronic certificate is acquired from the charger after the vehicle arrives at the charging station when the number of previous failures in the acquiring of the electronic certificate from the charger is less than the predetermined number of times. When the number of previous failures in the acquiring of the electronic certificate from the charger is less than the predetermined number of times, it is considered that the failure in the acquiring of the electronic certificate from the charger is unlikely to occur. Therefore, the electronic certificate can be acquired more reliably by acquiring the electronic certificate from the charger after the vehicle arrives at the charging station when the number of previous failures in the acquiring of the electronic certificate from the charger is less than the predetermined number of times. As a result, the power storage device mounted on the vehicle can be charged more reliably with the electric power from the charger installed in the charging station.

A third aspect of the present disclosure relates to a billing setting method of setting, in a vehicle including a power storage device and a communication device configured to exchange information by at least wireless communication, a billing method for charging of the power storage device with electric power from a charger installed in a charging station. The billing setting method includes determining whether an electronic certificate to be used for charging the power storage device with the electric power from the charger is acquirable by the wireless communication using the communication device before the vehicle arrives at the charging station based on a travel route from a current location to a destination and a location of the charging station, and acquiring the electronic certificate by the wireless communication using the communication device before the vehicle arrives at the charging station and setting the billing method to a first method of billing that uses the acquired electronic certificate when a determination is made that the electronic certificate is acquirable by the wireless communication using the communication device before the vehicle arrives at the charging station, and setting the billing method to a second method of billing that does not use the electronic certificate when a determination is made that the electronic certificate is not acquirable by the wireless communication using the communication device before the vehicle arrives at the charging station.

In the billing setting method according to the present disclosure, a determination is made as to whether the electronic certificate to be used for charging the power storage device with the electric power from the charger is acquirable by the wireless communication using the communication device before the vehicle arrives at the charging station based on the travel route from the current location to the destination and the location of the charging station. The electronic certificate is acquired by the wireless communication using the communication device before the vehicle arrives at the charging station and the billing method is set to the first method of billing that uses the acquired electronic certificate when the determination is made that the electronic certificate is acquirable by the wireless communication using the communication device before the vehicle arrives at the charging station. Therefore, the power storage device mounted on the vehicle can be charged more reliably with the electric power from the charger installed in the charging station. The billing method is set to the second method of billing that does not use the electronic certificate when the determination is made that the electronic certificate is not acquirable by the wireless communication using the communication device before the vehicle arrives at the charging station. Therefore, the power storage device mounted on the vehicle can be charged with the electric power from the charger installed in the charging station when the electronic certificate is not acquirable by the wireless communication using the communication device. As a result, the power storage device mounted on the vehicle can be charged more reliably with the electric power from the charger installed in the charging station.

In the billing setting method according to the present disclosure, the setting of the billing method may include, in a case where the determination is made that the electronic certificate is not acquirable by the wireless communication using the communication device before the vehicle arrives at the charging station, acquiring the electronic certificate from the charger after the vehicle arrives at the charging station and setting the billing method to the first method when the number of previous failures in the acquiring of the electronic certificate from the charger is less than a predetermined number of times, and setting the billing method to the second method when the number of failures is equal to or more than the predetermined number of times. When the number of previous failures in the acquiring of the electronic certificate from the charger is less than the predetermined number of times, it is considered that the failure in the acquiring of the electronic certificate from the charger is unlikely to occur. Therefore, the electronic certificate can be acquired more reliably by acquiring the electronic certificate from the charger after the vehicle arrives at the charging station when the number of previous failures in the acquiring of the electronic certificate from the charger is less than the predetermined number of times. Since the billing method is set to the first method, that is, the method of paying a charging fee by using the acquired electronic certificate, the billing method can be set more appropriately. When the number of previous failures in the acquiring of the electronic certificate from the charger is equal to or more than the predetermined number of times, it is considered that the failure in the acquiring of the electronic certificate from the charger is likely to occur. Since the billing method is set to the second method, that is, the method of paying a charging fee without using the acquired electronic certificate, the billing method can be set more appropriately even when the electronic certificate cannot be acquired. As a result, the power storage device mounted on the vehicle can be charged more reliably with the electric power from the charger installed in the charging station.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle-charging system 1 according to the present disclosure; and

FIG. 2 is a flowchart illustrating an example of a charging process routine.

### DETAILED DESCRIPTION OF EMBODIMENTS

Embodiments of the present disclosure will now be described with reference to the drawings.

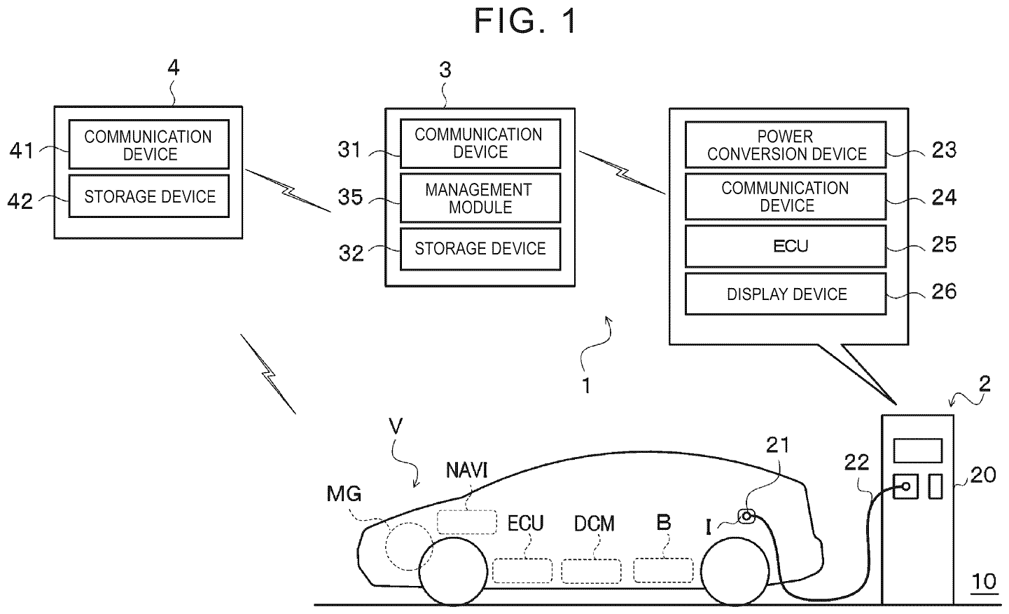

FIG. 1 is a schematic configuration diagram showing a vehicle charging system 1 of the present disclosure. The vehicle-charging-system 1 shown in FIG. 1 includes a charger 2 capable of externally charging a battery electric vehicle V battery B, a management server 3, and an authentication server 4.

Battery electric vehicle V is a battery electric vehicle (BEV) including a motor MG for exchanging electric power with the battery B via a power control device (PCU) (not shown) in addition to the battery B serving as an electric storage device, or a plug-in hybrid electric vehicle (PHEV). Battery electric vehicle V includes, in addition to the battery B and the motor MG2, a communication device DCM capable of wirelessly communicating with the authentication server 4, a navigation device NAVI, and an electronic control unit ECU for controlling the motor MG and the communication device DCM.

Although not shown, the navigation device NAVI includes a main body having a built-in control unit, a GPS antenna that receives information about the current location of the vehicle, and a touch panel type display. The control unit of the main body includes a storage medium (for example, a hard disk or an SSD), an input/output port, and a communication port in which map information and the like are stored. In the map information, service information such as a charging station 10 and a parking lot, road information in each traveling section (for example, between traffic lights, between intersections, and the like) and the like are stored as a database. When a destination is set by the user's operation of the display, the control unit of the main body of the navigation device NAVI sets a travel route from the current position of the own vehicle to the destination based on the map information stored in the main body, the current position of the own vehicle from GPS antenna, and the destination, and displays the set travel route on the display to perform route guidance.

The electronic control unit ECU includes a computer (not shown) having a CPU, a ROM, a RAM, an input/output port, a communication port, and the like. The electronic control unit ECU controls the motor MG. The electronic control unit ECU communicates with the communication device DCM and the navigational device NAVI via a communication port.

The charger 2 is installed in a so-called charging station 10. As illustrated in FIG. 1, the charger 2 includes a housing 20, a charging cable 22 including a charging connector 21, a power conversion device (power device) 23, a communication device 24, and an electronic control unit (hereinafter referred to as “ECU”) 25 as a charging control device. The charging cable 22 includes a positive-electrode-side power supply line connected to a positive-electrode terminal of the charging connector 21, a negative-electrode-side power supply line connected to a negative-electrode terminal of the charging connector 21, and a communication line connected to a signal terminal of the charging connector 21. Further, the charging cable 22 is connected to the power conversion device 23.

In the present embodiment, the power conversion device 23, the communication device 24, and ECU 25 are disposed in the housing 20. The power conversion device 23 includes a rectifier circuit, a transformer, a switching circuit, and the like, and converts AC power supplied from an AC power source such as a commercial power source into DC power. When the charging connector 21 is inserted into the charging inlet I of battery electric vehicle V, the power conversion device 23 is electrically connected to the charging inlet I via the charging cable 22 and the charging connector 21. The communication device 24 exchanges various kinds of information with the management server 3 and the like illustrated in FIG. 1 by wireless communication.

ECU 25 of the charger 2 includes a computer (not shown) having a CPU, a ROM, a RAM, and the like. When the charging connector 21 is inserted into the charging inlet I of battery electric vehicle V and the relaying of battery electric vehicle V is closed, ECU 25 controls the power conversion device 23 on the basis of a current sensor, a voltage sensor, or the like (both not shown). Accordingly, the battery B of the battery electric vehicle V is charged by the charger 2, that is, the electric power (DC electric power) from the power conversion device 23. ECU 25 also interacts with battery electric vehicle V electronic control unit ECU via the communication line of the charging cable 22 when the charging connector 21 is plugged into the charging inlet I of battery electric vehicle V.

Further, the charger 2 includes a display device 26 such as a liquid crystal display. The display device 26 is attached to the housing 20 and is controlled by an ECU 25. ECU 25 causes the display device 26 to display information to the user of battery electric vehicle V who has stopped in the parking space of the charging station 10. The information displayed on the display device 26 includes an instruction to use the charger 2 and an instruction to pay (charge) a charging fee by cash or a credit card.

The management server 3 is installed and managed by, for example, an operating company of the charging station 10, and functions as a management device that manages a usage state of a large number of chargers 2, a payment state of a charging fee, and the like in cooperation with a ECU 25 of the charger 2. The management servers 3 cooperate with ECU 25 of the charger 2 to authenticate payments. The management server 3 includes a computer (not shown) having a CPU, a ROM, a RAM, an input/output device, and the like, a communication device 31, and a storage device 32. As illustrated in FIG. 1, in the management server 3, a management module 35 is constructed by cooperation of hardware such as a CPU and a ROM, a RAM and a program installed in advance.

The communication device 31 exchanges various kinds of information with the communication device 24 of the charger 2, the authentication server 4, and the like by wireless or wired communication. The storage device 32 stores a data base that associates the usage status (usage history) of the charger 2, the payment status of the charging fee, the user identification information of the user such as the vehicle identification information and/or the battery electric vehicle V of a large number of vehicles including battery electric vehicle V, and the electronic certificate used when the battery B of battery electric vehicle V is charged in the charging station 10. The vehicle identification information includes a vehicle identification number (vehicle carriage number) and a vehicle number of battery electric vehicle V. The user identification information includes a contact information such as a driver's license number or a mobile telephone number of the user of battery electric vehicle V, a user ID given to the user (owner) of battery electric vehicle V by the manufacturer of the vehicle, and the like. The management module 35 executes the above-described database creation/update processing, information extraction from the database, and the like.

The authentication server 4 is installed and managed by, for example, a service provider that provides a service for issuing an electronic certificate, and functions as a certificate authority for issuing an electronic certificate. The authentication server 4 includes a computer (not shown) having a CPU, a ROM, a RAM, an input/output device, and the like, a communication device 41, and a storage device 42. The communication device 41 exchanges various kinds of information with the communication device 24 or the like of the charger 2 by wireless or wired communication. In addition, the communication device 41 exchanges various types of data with battery electric vehicle V communication device DCM by radio communication. The issued electronic certificate is stored in the storage device 42. CPU of the authentication server 4 issues an electronic certificate.

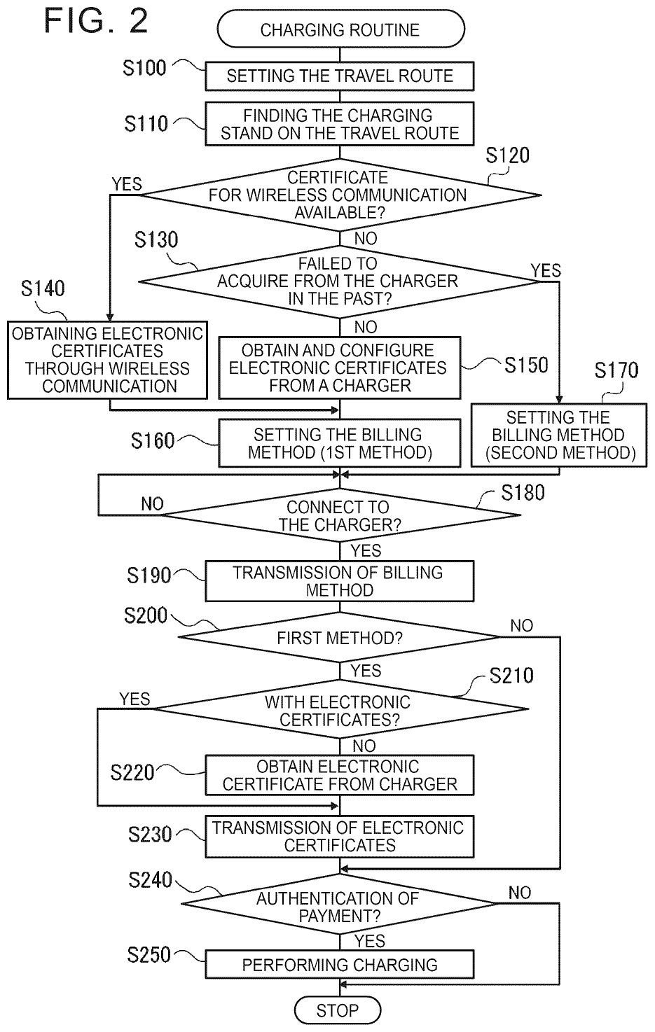

Next, the operation of the vehicle-charging-system 1 of the present disclosure, in particular, the operation when the battery B of battery electric vehicle V is charged by the electric power from the charger 2 will be described. FIG. 2 is a flow chart illustrating an exemplary charge process routine executed by the electronic control unit ECU of battery electric vehicle V. This routine is a flow chart illustrating routines executed by the cooperation of battery electric vehicle V navigator NAVI and the electronic control unit ECU. This routine is executed when the destination is set by the user operating the display of the navigational device NAVI. Note that battery electric vehicle V may be stopped running or running when the routine is started to be executed.

When this routine is executed, the control unit of the main body of the navigation device NAVI sets a travel route from the current position of the own vehicle to the destination on the basis of the map information stored in the main body, the current position of the own vehicle from GPS antenna, and the destination (S100). When battery electric vehicle V stops traveling, when the traveling route is set, battery electric vehicle V starts traveling by a user's action or the like.

Subsequently, the recommended charging station 10 is searched for and set on the traveling route (S110). When a plurality of charging stations 10 exist on the traveling route, the nearest charging station 10, the charging station 10 suitable for battery electric vehicle V charging use, and the like are set as the recommended charging stations 10.

CPU of the electronic control unit ECU determines whether or not the electronic certificate can be obtained from the authentication server 4 before reaching the charging station 10 retrieved by S110 through the radio communication via the communication device DCM (S120). In S120, it is determined that the electronic certificate cannot be acquired from the authentication server 4 when normal wireless communication cannot be performed between the authentication server 4 and the communication device DCM, for example, when wireless communication with the authentication server 4 is interrupted, or when there is a history in which wireless communication with the authentication server 4 has failed while traveling on the same traveling route in the past. When battery electric vehicle V starts traveling while S120 is being executed, S120 process is a process of determining whether or not an electronic certificate can be obtained by radio communication using the communication device DCM on the traveling route until battery electric vehicle V arrives at the charging station 10. When the electronic certificate can be obtained by S120 before reaching the charging station 10, the electronic certificate is obtained from the authentication server 4 by radio communication via the communication device DCM (S140). In this way, since the electronic certificate is acquired from the authentication server 4 by wireless communication when the electronic certificate can be acquired before arriving at the charging station 10, the electronic certificate can be acquired more reliably. Then, the charging method of charging battery electric vehicle V battery B by the electric power from the charger 2 is set to the first method (S160). In the first method, when battery electric vehicle V battery B is charged by the electric power from the charger 2, battery electric vehicle V is authenticated by using the electronic certificate and billing is performed.

When it is determined that the electronic certificate cannot be acquired by S120, it is determined whether or not the electronic certificate has failed to be acquired from the charger 2 installed in the charging station 10 which has been searched for by S110 in the past (S130). In S130, it is determined that the acquisition of the electronic certificate has failed when the number of failed attempts to acquire the electronic certificate from the charger 2 installed in the charging station 10 previously searched by S110 is equal to or more than a predetermined number of times (for example, 2 times, 3 times, 4 times, or the like). When the number of failed attempts to acquire the electronic certificate from the charger 2 installed in the charging station 10 previously searched by S110 is less than the predetermined number of times, it is determined that the acquisition of the electronic certificate has not failed. When S130 has not failed to acquire the electronic certificate from the charger 2 in the past, it is set that the electronic certificate is acquired from the charger 2 when connected to the charger 2 (S150), and the charging method when battery electric vehicle V battery B is charged by the electric power from the charger 2 via the charging cable 22 is set to the first method (S160). When S130 has failed to acquire the electronic certificate from the charger 2 in the past, the charging method for charging battery electric vehicle V battery B by the electric power from the charger 2 is set to the second method (S170). In the second method, when battery electric vehicle V battery B is charged by the electric power from the charger 2, the charging is performed by using cash, a credit card, or the like without using the electronic certificate.

Subsequently, battery electric vehicle V arrives at the charging station 10. Then, the charging connector 21 is inserted into the charging inlet I of battery electric vehicle V. After that, it is connected to the charger 2 via the communication line of the charging cable 22, and waits until it is possible to exchange information with each other (S180). When battery electric vehicle V is connected to the charger 2, the charging method set by S160 or S170 is transmitted to ECU 25 of the charger 2 via the communication line of the charging cable 22 (S190). When the billing method is the first method, ECU 25 waits until the electronic certificate is transmitted from battery electric vehicle V or battery electric vehicle V requests to acquire the electronic certificate. When the billing method is the second method, the display device 26 displays the guidance of the method of paying the charging fee by cashless payment, and waits for an input from the user via the display device 26. When the user enters cash as a payment-method, the authentication information is transmitted to the electronic control unit ECU of battery electric vehicle V via the communication line of the charging cable 22. When a credit card is input as a payment method from the user, the user waits for input of user authentication information necessary for authentication of the user. When the user authentication information is inputted via the display device 26, the user authentication information is authenticated based on the user authentication information in cooperation with the management server 3, and the authentication result is transmitted to battery electric vehicle V electronic control unit ECU via the communication line of the charging cable 22.

Subsequently, it is determined whether or not the billing method is the first method (S200). When the billing method is the first method, it is determined whether or not the electronic certificate has been acquired (S210). When the electronic certificate has been acquired, the acquired electronic certificate is transmitted to the charging ECU 52 of the charger 2 via the communication line of the charging cable 22 (S230). When the electronic certificate has not been acquired, the electronic certificate is acquired from the charging ECU 52 of the charger 2 via the communication line of the charging cable 22 (S220). In acquiring the electronic certificate, the electronic control unit ECU first transmits the certificate acquisition request and the vehicle identification information to the charging ECU 52 of the charger 2 via the communication line of the charging cable 22. The charging ECU 5 that has received the certificate obtaining request and the vehicle identification information cooperates with the management module 35 of the management server 3 to obtain the electronic certificate corresponding to the vehicle identification information from the database stored in the storage device 32 of the management server 3. Then, the charging ECU 5 transmits the electronic certificate to battery electric vehicle V electronic control unit ECU via the communication line of the charging cable 22. The electronic control unit ECU thus obtains the electronic certificate. Then, the obtained electronic certificate is transmitted to the charging ECU 52 of the charger 2 via the communication line of the charging cable 22 (S230). The charging ECU 52 of the charger 2 that has received the electronic certificate authenticates the payment using the electronic certificate received in cooperation with the management server 3. Then, the charging ECU 52 transmits the authentication result to the electronic control unit ECU of battery electric vehicle V via the communication line of the charging cable 22.

The electronic control unit ECU determines whether the payment (first method) is authenticated based on the received authentication (S240). When the payment is authenticated, battery electric vehicle V battery B is charged by the electric power from the charger 2 via the charging cable 22 (S250), and the routine ends. If the payment is not authenticated, the routine ends.

When the billing method is not the first method in S200, that is, when the billing method is the second method, it is determined whether the payment (second method) is authenticated (S240). When the payment is authenticated, battery electric vehicle V battery B is charged by the electric power from the charger 2 (S250), and the routine ends. If the payment is not authenticated, the routine ends.

When a failure occurs in the communication between the charger 2 and the management server 3 of the charging station 10, even if the charging connector 21 is inserted into the charging inlet I of battery electric vehicle V, the electronic certificate cannot be acquired via the communication line of the charging cable 22, and the charging of the battery B by the electric power from the charger 2 via the charging cable 22 may not be executed. In the vehicle charging system 1 of the present embodiment, it is determined whether or not an electronic certificate can be acquired by radio communication using the communication device DCM on the basis of the traveling route from the current location to the destination and the position of the charging station 10. When it is determined that the electronic certificate can be acquired by wireless communication using the communication device DCM before battery electric vehicle V arrives at the charging station 10, the electronic certificate is acquired by wireless communication using the communication device DCM. Thus, the electronic certificate can be more reliably obtained prior to arrival at the charging station 10, and the battery B mounted on battery electric vehicle V can be more reliably charged with electric power from the charger 2.

Further, when it is determined that the electronic certificate cannot be acquired by the wireless communication using the communication device DCM until battery electric vehicle V arrives at the charging station 10, when the number of failures in acquiring the electronic certificate from the charger 2 via the communication line of the charging cable 22 in the past is less than the predetermined number of times, since the electronic certificate is acquired from the charger 2 after the charging connector 21 arrives at the charging station 10 is inserted into the charging inlet I of battery electric vehicle V, it is possible to acquire the electronic certificate more reliably. Therefore, the battery B can be more reliably charged with electric power from the charger 2 installed in the charging station 10.

Further, when it is determined that the electronic certificate cannot be acquired by the radio communication using the communication device DCM until battery electric vehicle V arrives at the charging station 10, and when the number of failures in acquiring the electronic certificate from the charger 2 in the past is less than the predetermined number of times, the electronic certificate is acquired from the charger 2 after the arrival at the charging station 10, and the charging method is set to the first method, and when the number of failures is equal to or more than the predetermined number of times, the charging method is set to the second method, whereby the battery B mounted on battery electric vehicle V can be charged with electric power from the charger 2 installed in the charging station 10 more reliably.

In the above-described embodiment, when the electronic certificate can be acquired from the authentication server 4 on the traveling route by arriving at the charging station 10 searched by S110 by wireless communication via the communication device DCM, the electronic certificate is acquired by wireless communication. The timing of acquiring the electronic certificate may be any timing as long as it is a timing until it arrives at the charging station 10. In addition, in a case where the communication fee for acquiring the electronic certificate by wireless communication is high, the electronic certificate may not be acquired. Further, when the communication fee at the time of acquiring the electronic certificate by the radio communication becomes high, a selection screen for selecting whether or not to acquire the electronic certificate is displayed on the display of the navigation device NAVI of battery electric vehicle V or the screen of the portable terminal of the user, when it is selected not to acquire the electronic certificate, without acquiring the electronic certificate, when it is selected to acquire the electronic certificate, it may acquire the electronic certificate.

In the above-described embodiment, when the electronic certificate cannot be acquired from the authentication server 4 on the traveling route by the time of reaching the charging station 10 searched by S110 by the radio communication via the communication device DCM, it is determined whether or not the acquisition of the electronic certificate from the charger 2 has failed in S130 in the past. However, when the electronic certificate cannot be acquired from the authentication server 4 on the traveling route by the time it arrives at the charging station 10 retrieved by S110 through the radio communication via the communication device DCM without executing S130, S150, the charging method may be set to the second method.

In the above-described embodiment, the traveling route is set from S100 to S120. Then, the charging station 10 on the traveling route is searched. Thereafter, it is determined whether or not the electronic certificate can be acquired from the authentication server 4 on the traveling route by arriving at the charging station 10 retrieved by S110 through the radio communication via the communication device DCM. However, it is determined whether or not the acquisition of the electronic certificate from the charger 2 has failed in S130 in the past without executing S120 from S100, and when the acquisition of the electronic certificate has not failed, the electronic certificate may be acquired through the communication line of the charging cable 22 after the charging connector 21 arrives at the charging station 10 and is inserted into the charging inlet I of battery electric vehicle V.

In the above-described embodiment, when the electronic certificate cannot be acquired from the authentication server 4 on the traveling route by S120 before reaching the charging station 10 searched by S110 by the radio communication via the communication device DCM, it is determined whether or not the acquisition of the electronic certificate from the charger 2 has failed in S130 in the past. However, when the electronic certificate cannot be acquired from the authentication server 4 on the traveling route until it arrives at the charging station 10 searched by S110 by the wireless communication via the communication device DCM in S120, the history of acquiring the electronic certificate from the charger 2 in the past is examined, if there is no history, it may be tried to acquire the electronic certificate from the charger 2 via the communication line of the charging cable 22. In this case, whether or not the electronic certificate has been acquired and the position information of the charging station 10 may be stored in the storage device of the electronic control unit ECU, or may be stored in the management server 3 via the charger 2. When there is no history of acquiring the electronic certificate from the charger 2 in the past, the acquisition of the electronic certificate by the charger 2 may be prohibited. Further, S130 may determine whether or not the acquisition of the electronic certificate from the charger 2 has failed in the past, based on the acquisition history of the electronic certificate from the management server 3 via the charger 2 in another battery electric vehicle V in the past.

It should be noted that the correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a device for acquiring an electronic certificate, a manufacturing industry of a product using a billing setting device, and the like.

What is claimed is:

1. A method of acquiring, in a vehicle including a power storage device and a communication device configured to exchange information by at least wireless communication, an electronic certificate to be used for charging the power storage device with electric power from a charger installed in a charging station, the method comprising:
determining whether the electronic certificate is acquirable by the wireless communication using the communication device before the vehicle arrives at the charging station based on a travel route from a current location to a destination and a location of the charging station; and
acquiring the electronic certificate by the wireless communication using the communication device before the vehicle arrives at the charging station when a determination is made that the electronic certificate is acquirable by the wireless communication using the communication device before the vehicle arrives at the charging station.

2. The method according to claim 1, wherein
the acquiring of the electronic certificate includes acquiring the electronic certificate from the charger after the vehicle arrives at the charging station when a determination is made that the electronic certificate is not acquirable by the wireless communication using the communication device before the vehicle arrives at the charging station and the number of previous failures in the acquiring of the electronic certificate from the charger is less than a predetermined number of times.

3. A method of acquiring, in a vehicle including a power storage device, an electronic certificate to be used for charging the power storage device with electric power from a charger installed in a charging station, the method comprising
acquiring the electronic certificate from the charger after the vehicle arrives at the charging station when the number of previous failures in the acquiring of the electronic certificate from the charger is less than a predetermined number of times.

4. A billing setting method of setting, in a vehicle including a power storage device and a communication device configured to exchange information by at least wireless communication, a billing method for charging of the power storage device with electric power from a charger installed in a charging station, the billing setting method comprising:
determining whether an electronic certificate to be used for charging the power storage device with the electric power from the charger is acquirable by the wireless communication using the communication device before the vehicle arrives at the charging station based on a travel route from a current location to a destination and a location of the charging station; and
acquiring the electronic certificate by the wireless communication using the communication device before the vehicle arrives at the charging station and setting the billing method to a first method of billing that uses the acquired electronic certificate when a determination is made that the electronic certificate is acquirable by the wireless communication using the communication device before the vehicle arrives at the charging station, and setting the billing method to a second method of billing that does not use the electronic certificate when a determination is made that the electronic certificate is not acquirable by the wireless communication using the communication device before the vehicle arrives at the charging station.

5. The billing setting method according to claim 4, wherein
the setting of the billing method includes, in a case where the determination is made that the electronic certificate is not acquirable by the wireless communication using the communication device before the vehicle arrives at the charging station, acquiring the electronic certificate from the charger after the vehicle arrives at the charging station and setting the billing method to the first method when the number of previous failures in the acquiring of the electronic certificate from the charger is less than a predetermined number of times, and setting the billing method to the second method when the number of failures is equal to or more than the predetermined number of times.
